(19) United States
(12) Patent Application Publication
(10) Pub. No.: US 2011/0274862 A1
(43) Pub. Date: Nov. 10, 2011

(54) BONDED STRUCTURE, ROOF STRUCTURE, LAMINATED SHEET FOR USE THEREIN, AND METHOD OF USING LAMINATED SHEET

(75) Inventors: Shigeyuki Yaguchi, Saitama (JP); Hirofumi Shigeoka, Tochigi (JP); Tadahiro Tomino, Saitama (JP); Yohei Horiguchi, Tokyo (JP); Yoshitomo Ono, Saitama (JP)

(73) Assignees: Lintec Corporation, Tokyo (JP); Honda Motor Co., Ltd., Tokyo (JP)

(21) Appl. No.: 13/124,229

(22) PCT Filed: Aug. 19, 2009
(86) PCT No.: PCT/JP2009/064519

§ 371 Date: Jun. 30, 2011

(30) Foreign Application Priority Data
Oct. 14, 2008 (JP) 2008-265307

(51) Int. Cl. B32B 33/00; B32B 38/10

(52) U.S. Cl. 428/40.1; 156/711; 156/306.3; 156/272.4

(57) ABSTRACT

The present invention relates to a bonded matter prepared by bonding a first member to a second member with a laminated sheet, wherein a contractile film constituting the above laminated sheet contracts when the bonded matter is heated, and a part of the laminated sheet is peeled off or the laminated sheet is peeled off from the member, whereby the bonded matter is prevented from being deformed; a roof structure; a laminated sheet used for the above bonded matter, wherein at least a contractile film and a peelable layer are laminated in this order, and the peelable layer is bonded to one of the above members; and when the bonded matter is heated, the peelable layer is peeled off from the above member; and a use method of a laminated sheet characterized by sticking a peelable layer surface of the laminated sheet on one surface side of one member, adhering a contractile film surface of the laminated sheet to the other member with an adhesive and bonding one member to the other member. Provided are a bonded matter which can release bonding when heated, a roof structure, a laminated sheet used for the same and a use method of the laminated sheet.

### BACKGROUND OF THE INVENTION

The present invention relates to a bonded matter, a roof structure, a laminated sheet used for the same and a use method of the laminated sheet, specifically to a bonded matter in which bonding can be released when heated, a roof structure, a laminated sheet used for the same and a use method of the laminated sheet.

### RELATED ART

In a production line for automobiles, assembling and adhesion of car body panels constituted by outer plate panels such as roof steel plates and the like and reinforcing inner plate panels such as stiffeners and the like are carried out. That is, a steel plate on which a rust preventive oil is attached is cut and subjected to press processing, and then a mastic adhesive (called as well a mastic sealer) is coated on one of an outer plate panel and an inner plate panel obtained. The other panel is superposed thereon, and the panels are fixed and bonded. As described above, a mastic sealer (refer to, for example, a patent document 1) is used for assembling, adhesion and bonding of car body panels.

Next, the above car body panels are mounted in a car body, and then steps of alkali immersion and warm water shower are repeated several times in order to remove a rust preventive oil. Thereafter, steps of chemical treatment and shower washing, electrodeposition coating and then curing of the electrodeposition coating material by baking are carried out, and the mastic adhesive is cured as well at the same time. Then, middle coating, finish coating and surface coating are carried out.

In recent years, a reduction in a weight of cars is particularly required, and as a part thereof, application of a high tension material (a plate is thin and has a rigidity) as a roof steel plate is promoted. In this case, a difference in a thickness of a roof steel plate and a stiffener and a little contraction of a mastic sealer bring about distortion in a certain case in a part in which the roof steel plate having a small thickness is bonded by the mastic sealer after coated and dried.

The above phenomenon is not necessarily brought about in all parts bonded by the mastic sealer, and therefore a mastic sealer bonded part at a site where distortion is generated as a result of the structural analysis is cut by means of a knife to thereby cope with the above matter.
Patent document 1: Japanese Patent Application Laid-Open No. 302755/2007

### DISCLOSURE OF THE INVENTION

The present invention has been made in order to solve the problems described above, and an object thereof is to provide a bonded matter in which bonding can be released when heated, a roof structure, a laminated sheet used for the same and a use method of the laminated sheet.

Intensive researches repeated by the present inventors in order to solve the problem described above have resulted in finding that the object described above is achieved by providing a laminated sheet which can be peeled off when heated between a first member and a second member, and thus the present invention has been completed.

That is, the present invention provides a bonded matter prepared by bonding a first member to a second member with a laminated sheet, wherein a contractile film constituting the above laminated sheet contracts when the bonded matter is heated, and a part of the laminated sheet is peeled off or the laminated sheet is peeled off from the member, whereby the bonded matter is prevented from being deformed.

Further, the present invention provides a roof structure prepared by bonding a stiffener for cars and a roof for cars via a mastic sealer and a laminated sheet, wherein when the above roof structure is heated, a part of the laminated sheet is peeled off or the laminated sheet is peeled off from the stiffener for cars, whereby the roof structure is prevented from being deformed.

Also, the present invention provides a laminated sheet used for the above bonded matter, wherein at least a contractile film and a peelable layer are laminated in this order, and the peelable layer is bonded to one member; and when the bonded matter is heated, the peelable layer is peeled off from the above member (first embodiment); a laminated sheet in which at least a contractile film, a peelable layer, a base material and an adhesive layer are laminated in this order and in which when the bonded matter is heated, the peelable layer is peeled off from the base material (second embodiment); and a laminated sheet in which at least a contractile film, a second adhesive layer, a base material B, a peelable layer, a base material A and a first adhesive layer are laminated in this order and in which when the bonded matter is heated, the peelable layer is peeled off from the base material A (third embodiment).

Further, the present invention provides a use method of a laminated sheet, characterized by sticking a peelable layer surface or an adhesive layer surface in the laminated sheet of the present invention on one surface side of one member, adhering a contractile film surface of the laminated sheet to the other member with an adhesive and bonding one member to the other member.

Use of the laminated sheet and the bonded matter of the present invention makes it possible to release bonding when heated. It is suited to, for example, a roof structure, and use thereof for a part in which a stiffener for cars is bonded to a roof makes it possible to prevent the members from being deformed.

### BRIEF EXPLANATION OF THE DRAWINGS

FIG. 1 is an outline cross-sectional drawing showing the first embodiment in the laminated sheet of the present invention.

FIG. 2 is an outline cross-sectional drawing showing the second embodiment in the laminated sheet of the present invention.

FIG. 3 is an outline cross-sectional drawing showing the third embodiment in the laminated sheet of the present invention.

FIG. 4 is an outline drawing showing a use method using the laminated sheet of the present invention and an example in which the layer is peeled off.

FIG. 5 is an outline drawing showing a state in which the contractile film in the laminated sheet of the present invention contracts.

FIG. 6 is an outline drawing for explaining a peeling force test method in the examples and the comparative examples.

FIG. 7 is an outline cross-sectional drawing showing the roof structure of the present invention.

### EXPLANATION of CODES

1, 10, 20: Laminated sheets
2: Contractile film
3: Peelable layer
4: Base material
4′: Base material A
5: Adhesive layer
5′: First adhesive layer
6: Second adhesive layer
7: Base material B
31: Upper member (roof steel plate)
32: Adhesive (mastic sealer)
33: Lower member (stiffener)

### BEST MODE FOR CARRYING OUT THE INVENTION

The bonded matter of the present invention is a bonded matter prepared by bonding a first member to a second member with a laminated sheet, wherein a contractile film constituting the above laminated sheet contracts when the bonded matter is heated, and a part of the laminated sheet is peeled off or the laminated sheet is peeled off from either of the members, whereby the bonded matter is prevented from being deformed.

As shown in, for example, FIG. 7, the bonded matter is used as a roof structure prepared by bonding a stiffener 33 for cars and a roof 31 for cars via a mastic sealer 32 and a laminated sheet 1, 10, 20, wherein when the above roof structure is heated, a part of the laminated sheet 1, 10, 20 is peeled off or the laminated sheet 1 is peeled off from the stiffener 33 for cars, whereby the roof structure is prevented from being deformed.

The members described above are preferably members for cars, and the member and the member different from the above member are preferably a stiffener for cars and a roof for cars.

In addition thereto, the bonded matter of the present invention can be used as well for members of ships, electric trains and the like in the fields of traffic, transportation and the like.

In the laminated sheet 1 of the present invention used for the bonded matter described above, at least a contractile film 2 and a peelable layer 3 are laminated, as shown in FIG. 1, in this order as the first embodiment, and when the bonded matter prepared by using the above laminated sheet 1 is heated, the peelable layer 3 is peeled off from a member 33.

In the second embodiment, a laminated sheet 10 is prepared by laminating, as shown in FIG. 2, at least a contractile film 2, a peelable layer 3, a base material 4 and an adhesive layer 5 in this order, and when a bonded matter prepared by using the above laminated sheet 10 is heated, the peelable layer 3 is peeled off from the base material 4.

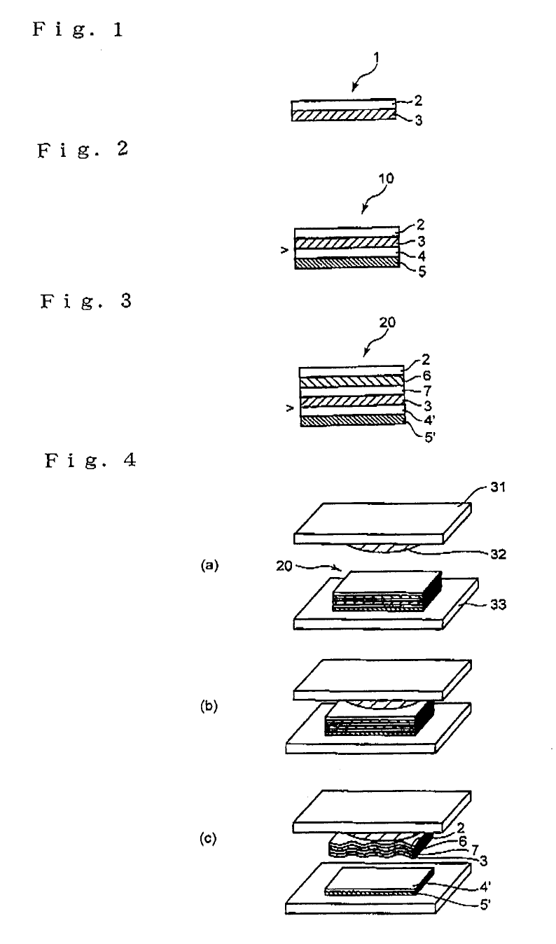

In the third embodiment, a laminated sheet 20 is prepared by laminating, as shown in FIGS. 3 and 4, at least a contractile film 2, a second adhesive layer 6, a base material B 7, a peelable layer 3, a base material A 4′ and a first adhesive layer 5′ in this order, and when a bonded matter prepared by using the above laminated sheet 20 is heated, the peelable layer 3 is peeled off from the base material A 4′.

In FIGS. 2 and 3, the mark > shows a place where the layers are peeled off.

The contractile film 2 used in the present invention shall not specifically be restricted as long as it has a heat resistance, a chemical resistance and a durability and is provided with a contactility exerted by heating, and used are polyester films comprising polyethylene terephthalate resins, polybutylene terephthalate resins and the like, vinyl chloride films and the like. The contractile film 2 which is liable to be adhered to a mastic sealer, an adhesive layer and a peelable layer each described later has to be used.

Among the contractile films 2 described above, the films having a larger contraction percentage in one direction than a contraction percentage in the other direction are particularly preferred, and a contraction percentage thereof (95° C.) in one direction is 30% or more, preferably 30 to 90% and particularly preferably 40 to 80%. If the contraction percentage in the other direction is the same as the contraction percentage in one direction described above, the mastic sealer provided on the contractile film protrudes in a certain case. Accordingly, the contraction percentage in the other direction is 20% or less, preferably 15% or less.

The term “one direction” in the above case shows either longitudinal or lateral direction of the laminated sheet (rectangular), and the term “the other direction” shows a direction different by 90 degrees from above one direction.

A shape of the contractile film 2 observed when it contacts due to heat includes a corrugate shape shown in FIG. 5 (a) which is observed from a side part and a shape which is warped in a semicircular form as shown in FIG. 5 (b), and it shall not specifically be restricted.

In the present invention, the contractile film 2 can be subjected, if desired, on one surface or both surfaces to surface treatment by an oxidation method, a roughening method and the like for the purpose of enhancing an adhesive property with an adhesive layer and a peelable layer described later which are provided on the contractile film. The oxidation method described above includes, for example, corona discharge treatment, plasma treatment, chromic acid treatment (wet), UV ray irradiation treatment and the like, and the roughening method includes, for example, a sand blast method, a solvent treating method and the like. The above surface treating methods are suitably selected according to the kind of the base material. Further, the contractile film subjected on one surface or both surfaces to primer treatment can be used as well.

A thickness of the contractile film 2 shall not specifically be restricted, and the film having a thickness of 20 to 100 μm is used considering a contractile force, a heat resistance and a durability.

The base material 4, the base material A 4′ and the base material B 7 which are used for the laminated sheet of the present invention shall not specifically be restricted as long as they have a heat resistance, a chemical resistance and a durability, and used are polyester films comprising polyethylene terephthalate resins, polyethylene naphthalate resins, polybutylene terephthalate resins and the like, polypropylene films, polyamide films, polyimide films, metal foils and the like.

Further, the base material 4, the base material A 4′ and the base material B 7 can be subjected, if desired, on one surface or both surfaces to surface treatment by an oxidation method, a roughening method and the like for the purpose of enhancing an adhesive property with an adhesive layer and a peelable layer described later which are provided on the base materials. The oxidation method described above includes, for example, corona discharge treatment, plasma treatment, chromic acid treatment (wet), flame treatment, hot blast treatment, ozone-UV ray irradiation treatment and the like, and the roughening method includes, for example, a sand blast method, a solvent treating method and the like. The above surface treating methods are suitably selected according to the kind of the base materials, and in general, the corona discharge treating method is preferably used in terms of effects and an operability. Further, the base materials subjected on one surface or both surfaces to primer treatment can be used as well.

A thickness of the base material 4, the base material A 4′ and the base material B 7 shall not specifically be restricted, and the base materials having a thickness of 10 to 200 μm is used considering a heat resistance, a durability and the like.

The peelable layer 3 which is a pivot in the present invention has two functional forms.

One is the property that it is peeled off from the other materials strongly following the contractile film 2 or the base material B 7. In this case, an self-adhesive resin comprising a so-called acryl resin, a silicone resin having a large film thickness and the like is preferably bused.

In a case of using, for example, an self-adhesive resin comprising an acryl resin, a silicone resin having a large film thickness and the like, the self-adhesive resin is coated directly on the base material B 7 which is intended to be improved in adhesion to form the peelable layer 3 and then laminated on the other base material A 4′, and the base material is peeled off, whereby the peelable layer 3 comes to follow, due to a difference in an adhesive property, the base material B 7 on which the peelable layer 3 is formed. Incidentally, means such as providing an anchorcoat layer, carrying out corona treatment and the like can be used as well in order to expedite more the effects thereof.

Further, a method for reducing the adhesive property by partially forming a plane form stuck on the base material A 4′ for the peelable layer 3 on a surface in which an adhesive property is weakened can be used as well.

In the other functional form, the peelable layer 3 is broken within the layer and divided into two layers. In this case, 10 to 150 parts by mass of particles such as silica, glass beads and the like having a particle size of 0.1 to 5 μm is blended with 100 parts by mass of a binder resin such as an acryl resin, a cellulose resin, a polyester resin, a urethane resin and the like to prepare a composition, and a layer formed from the composition prepared above in a thickness of 1 to 20 μm is used.

The adhesive layer 5, the first adhesive layer 5′ and the second adhesive layer 6 shall not specifically be restricted as long as they have a heat resistance, a chemical resistance, a durability and a strong adhesive property, and a pressure-sensitive adhesive composition comprising a pressure-sensitive adhesive as a principal agent can be used.

The pressure-sensitive adhesive includes, for example, acryl base pressure-sensitive adhesives, polyester base pressure-sensitive adhesives, urethane base pressure-sensitive adhesives, silicone base pressure-sensitive adhesives and the like. In particular, the acryl base pressure-sensitive adhesives are preferably used from the viewpoint of a sticking aptitude to a metal base adherend (a member 33 in FIG. 4).

When the pressure-sensitive adhesive is, for example, an acryl base pressure-sensitive adhesive, it can be constituted from a polymer or a copolymer comprising principally a main monomer component for providing an adhesive property, a comonomer component for providing an adhesive property and a cohesive force and a functional group-containing monomer component for improving a cross-linking point and an adhesive property.

The main monomer component includes, for example, acrylic acid alkyl esters such as ethyl acrylate, butyl acrylate, amyl acrylate, 2-ethylhexyl acrylate, octyl acrylate, cyclohexyl acrylate, benzyl acrylate, methoxyethyl acrylate and the like and methacrylic acid alkyl esters such as butyl methacrylate, 2-ethylhexyl methacrylate, cyclohexyl methacrylate, benzyl methacrylate and the like.

The comonomer component includes, for example, methyl acrylate, methyl methacrylate, ethyl methacrylate, vinyl acetate, styrene, acrylonitrile and the like.

The functional group-containing monomer component includes, for example, carboxyl group-containing monomers such as acrylic acid, methacrylic acid, maleic acid, itaconic acid and the like, hydroxyl group-containing monomers such as 2-hydroxyethyl acrylate, hydroxyethyl methacrylate, 2-hydroxypropyl acrylate, 2-hydroxypropyl methacrylate, N-methylolacrylamide and the like, acrylamide, methacrylamide, glycidyl methacrylate and the like.

The pressure-sensitive adhesive composition is improved in a pressure-sensitive adhesive force and a cohesive force by adding the above respective components. Usually, the above acryl base resins do not have unsaturated bonds in a molecule and therefore can be improved in a stability against light and oxygen. Further, suitable selection of the kind of the monomers and the molecular weight makes it possible to obtain the pressure-sensitive adhesive composition provided with a quality and characteristics according to uses.

The composition of either of a cross-linking type subjected to cross-linking treatment and a non-cross-linking type subjected to no cross-linking treatment may be used for the above pressure-sensitive adhesive composition, and the composition of the cross-linking type is more preferred. When the composition of the cross-linking type is used, the adhesive layer having more excellent cohesive force can be formed.

A cross-linking agent used for the cross-linking type pressure-sensitive adhesive composition includes epoxy base compounds, isocyanate compounds, metal chelate compounds, metal alkoxides, metal salts, amine compounds, hydrazine compounds, aldehydes compounds and the like. A use amount of the cross-linking agent is selected in a range of usually 0.1 to 10 parts by mass, preferably 0.5 to 5 parts by mass based on 100 parts by mass of the pressure-sensitive adhesive described above.

Various additives, for example, an antioxidant, a tackifier, a UV absorber, a light stabilizer, a coupling agent, a filler, a colorant and the like can be added to the above pressure-sensitive adhesive composition as long as the objects of the present invention are not damaged.

Also, the adhesive layer 5 and the first adhesive layer 5′ may be a magnetic adhesive layer comprising a magnetic adhesive composition containing a mixture of a hot melt adhesive and a ferromagnetic substance in addition to the pressure-sensitive adhesive composition described above.

If the above magnetic adhesive layer is used as the adhesive layer 5, the laminated sheet can be bonded to the member by a magnetic force.

The hot melt adhesive described above is an adhesive which has a tack or scarcely has a tack at ordinary temperature and which is softened by heating to exert an adhesive property and is solidified by cooling to ordinary temperature to exhibit adhesion, and it includes polyolefin resin base hot melt adhesives, polyester resin base hot melt adhesives and the like. When applied to a surface of an adherend on which oil is coated, a polyolefin resin base hot melt adhesive is particularly preferred.

The specific examples of the polyolefin resin base hot melt adhesives include propylene-ethylene-butene-1 copolymers, ethylene-vinyl acetate copolymers s and the like.

The specific examples of the polyester resin base hot melt adhesives include polycondensation products of a dicarboxylic acid component and a diol component. The dicarboxylic acid component includes terephthalic acid, isophthalic acid, lower alkyl esters thereof, malonic acid, succinic acid, adipic acid, sebacic acid and the like. The diol component includes ethylene glycol, 1,3-propanediol, 1,4-butanediol, 1,5-pentanediol, 1,6-hexanediol, diethylene glycol, triethylene glycol, polyethylene glycol, cyclohexanedimethanol, neopentyl glycol, polytetramethylene glycol and the like. Each at least one of the above dicarboxylic acid components and diol components is used to obtain the polyester resin base hot melt adhesives.

A melting point of the hot melt adhesive is preferably 90 to 200° C., more preferably 110 to 180° C.

The ferromagnetic substance described above is a substance which can be spontaneously magnetized without having an external magnetic field, and ferrimagnetic substances are included therein as well. To be specific, it includes ferrites such as iron, cobalt, nickel, barium ferrites, strontium ferrite and the like, rare earth metal magnetic substances such as rare earth metal cobalt magnets and the like and alnico magnets. Among them, the ferrites are preferred in order to finely control an initial magnetism.

The ferromagnetic substance is preferably a powder (hereinafter called a magnetic powder). An average particle diameter of the magnetic powder is preferably 0.5 to 20 μm, more preferably 0.5 to 15 μm and particularly preferably 1 to 5 μm.

A mixing proportion of the magnetic powder is preferably 100 to 400 parts by mass, more preferably 120 to 350 parts by mass and particularly preferably 150 to 300 parts by mass based on 100 parts by mass of the hot melt adhesive.

The magnetic powder is dispersed in the hot melt adhesive preferably by mixing the hot melt adhesive with the magnetic powder under heating. The heating temperature is preferably 100 to 220° C., more preferably 120 to 180° C. The above heating temperature is preferably higher by 10° C. or higher, more preferably by 20 to 70° C. than a melting temperature of the hot melt adhesive. Mixing them in the above temperature range makes it possible to evenly disperse the magnetic powder in the hot melt adhesive and prevent the hot melt adhesive from changing in a quality.

The magnetic adhesive layer described above exerts a desired adhesive performance in a state in which the magnetic powder in the adhesive composition is magnetized. Accordingly, the hot melt may be mixed with the magnetic powder which is magnetized or the hot melt may be mixed with the magnetic powder which is not magnetized. In the latter case, the magnetic powder can be magnetized (polarized) after mixing. It can be magnetized by a known method. When mixing the hot melt adhesive with the magnetic powder under heating, the magnetic powder is demagnetized in a certain case, but in such case, the magnetic powder can be magnetized once again

The magnetic adhesive composition described above can suitably be blended with at least one of a tackifier, an antioxidant, a filler, a dispersant and the like. The adhesive composition of the present invention does not preferably contain a foaming agent in order to maintain a high adhesive strength.

The magnetic adhesive layer described above has a shearing force of 20 N or more, preferably 40 N or more after adhered under heating (150° C. for 10 minutes).

In the above case, the shearing force after adhered under heating (150° C. for 10 minutes) shows a shearing force of the adhesive sheet to a stainless steel plate, wherein a release sheet of the obtained adhesive sheet provided with the base material is removed, and the adhesive layer is stuck on the stainless steel plate (thickness: 3 mm) at ordinary temperature; and it is heated at 150° C. for 10 minutes and then cooled down to ordinary temperature to measure a shearing force according to JIS K6850. The test speed is set to 300 mm/minute.

The magnetic adhesive layer used in the present invention has a surface magnetic force of preferably 20 mT or more, more preferably 25 to 100 mT at ordinary temperature. In this connection, the surface magnetic force at ordinary temperature shows a surface magnetic force measured by means of a gauss meter (trade name: 5080 type Handy Gauss Meter, manufactured by Toyo Technical Co., Ltd.) at ordinary temperature at a distance apart by 1 cm from a surface of the magnetic adhesive layer in the obtained adhesive sheet provided with the base material from which a release sheet is removed.

Further, the magnetic adhesive layer described above has a surface magnetic force of preferably less than 5 mT, more preferably 3 mT or less and most preferably 1.5 mT or less after heating. A lower limit value of the surface magnetic force is 0.

In the above case, the surface magnetic force after heating shows a surface magnetic force measured at a distance apart by 1 cm from a surface of the magnetic adhesive layer by means of the gauss meter described above after heating at 150° C. for 40 minutes, then cooling down to ordinary temperature and removing the release sheet.

As described above, the magnetic adhesive layer used in the present invention has a strong surface magnetic force at ordinary temperature before heating and has a tack or scarcely has a tack. Accordingly, the magnetic adhesive layer can be stuck on an adherend comprising metal only by a surface magnetic force thereof, and even if positioning thereof is mistaken, it can readily be corrected. Further, the magnetic adhesive layer described above exerts a strong adhesive force by heating and therefore is adhered firmly on an adherend comprising metal, and a surface magnetic force thereof can be reduced by heating, so that an effect of the magnetic force to human bodies and electronic devices can be inhibited to the utmost.

In the present invention, the adhesive layer may be formed by coating the adhesive composition directly on one surface of the base material described above, or the adhesive composition is coated directly on a release-treated surface of a release sheet described later and dried to form an adhesive layer, and then it may be stuck on one surface of the base material. A forming method of the adhesive layer shall not specifically be restricted, and various methods can be used and include, for example, an air knife coater, a blade coater, a bar coater, a gravure coater, a roll coater, a curtain coater, a die coater, a knife coater, a roll knife coater, a screen coater, a Mayer bar coater, a kiss coater and the like.

A thickness of the adhesive layers 5, 5′ and 6 is usually 10 to 100 μm, preferably 15 to 60 μm when the pressure-sensitive adhesive is used, and it is usually 5 to 400 μm, preferably 10 to 300 μm when the magnetic adhesive composition is used.

Further, in the present invention, a layer such as a readily adhesive lay and the like may be provided, if necessary, between the base material and the adhesive layers each described above.

The surfaces of the adhesive layers 5, 5′ are preferably covered with the release sheets until before used in order to protect them. Any materials may be used for the above release sheet, and capable of being used are, for example, materials in which used as base materials are films comprising various resins such as polyethylene terephthalate, polybutylene terephthalate, polyethylene, polypropylene, polyallylate and the like and various paper materials such as polyethylene-laminated papers, polypropylene-laminated papers, clay-coated papers, resin-coated papers, glassine papers, woodfree papers and the like and in which a bonded surface between the above base material and the adhesive layer is subjected, if necessary, to release treatment. In the above case, the representative example of the release treatment includes formation of a release agent layer comprising a release agent such as a silicone base resin, a long chain alkyl base resin, a fluorine base resin and the like.

A thickness of the release sheet shall not specifically be restricted and can suitably be selected.

Next, a use method for the laminated sheet of the present shall be explained with reference to FIG. 4. FIG. 4 shows an embodiment in which the laminated sheet 20 shown in FIG. 3 is used.

First, the laminated sheet 20 is stuck, as shown in FIG. 4 (a), on a surface of a lower member (stiffener) 33 with a first adhesive layer 5′. An adhesive (mastic sealer) 32 is coated on a bonded part of an upper member (roof steel plate) 31, and then the upper member is adhered, as shown in FIG. 4 (b), on the laminated sheet 20 and bonded by adhesion of the mastic sealer 32. Various washing and coating steps are carried out in this state. In the above state, the roof steel plate 31 and the stiffener 33 stay in a bonding state by the mastic sealer 32.

Next, when heated in the drying step, a contractile film 2 of the laminated sheet 20 contracts, and a contractile force thereof is exerted up to a peelable layer 3. The mastic sealer 32 is firmly adhered, as shown in FIG. 4 (c), to the contractile film 2 of the laminated sheet 20, and the peelable layer 3 of the laminated sheet 20 is peeled off from a base material A 4′, so that as a result thereof, the roof steel plate 31 is peeled off from the base material A 4′ in a form in which the roof steel plate is accompanied by the mastic sealer 32 and the contractile film 2, the second adhesive layer 6, the base material B 7 and the peelable layer 3 of the laminated sheet 20.

The mastic sealer 32 shall not specifically be restricted, and commercially available products shown in the patent document 1 can be used.

In the explanations described above and FIG. 4, the mastic sealer 32 is coated and formed on the roof steel plate 31 and bonded to the stiffener 33, but the mastic sealer 32 may be coated and formed on the contractile film 2 of the laminated sheet and then bonded to the roof steel plate 31.

### EXAMPLES

The present invention shall be explained in further details with reference to examples, but the present invention shall by no means be restricted by these examples.

In the following examples and comparative examples, a peeling force test was carried out in the following manner.

### Peeling Force Test:

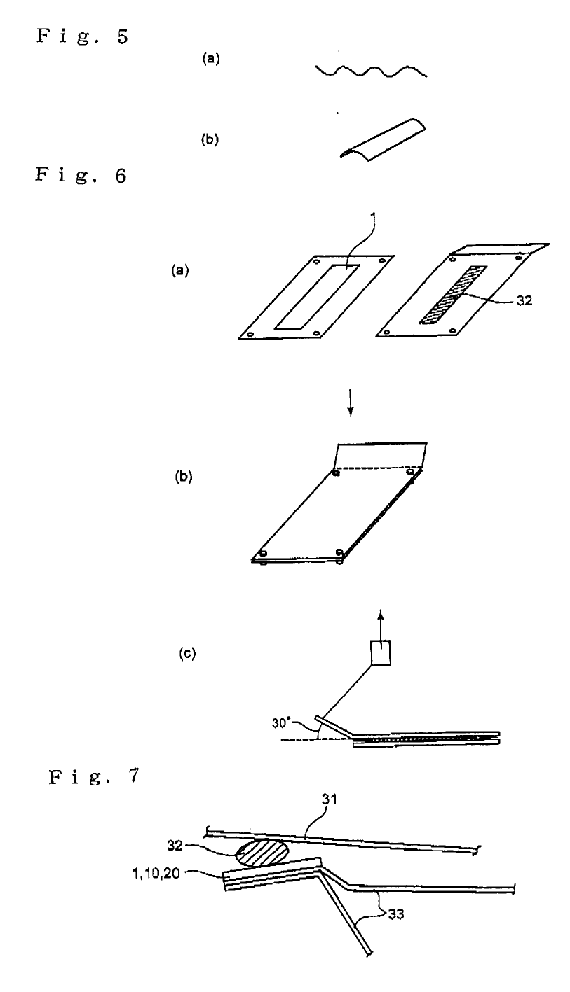

A laminated sheet (length: 100 mm, width: 25 mm) was stuck, as shown in FIG. 6 (a), by an adhesive layer on a central part of a SUS (stainless steel) plate having a length of 150 mm, a width of 70 mm and a thickness of 1.0 mm which had mounting holes at four corners. A mastic sealer 5 g was provided in a width of 10 mm, a length of 80 mm and a thickness of 5 mm on a central part of a SUS plate having a length of 180 mm (an end part 30 mm was bent at an angle of 30 degrees), a width of 70 mm and a thickness of 0.8 mm which had mounting holes as well at four corners so that the mastic sealer was located at a central part of the laminated sheet described above.

Then, the SUS plate on which the mastic sealer was coated was superposed thereon, as shown in FIG. 6 (b), so that the mastic sealer was located on the laminated sheet, and washers having a thickness of 3 mm were fit to the mounting holes to fix both ends thereof with bolts. This plate was put in an oven of 150° C. and left standing for one hour to cure the mastic sealer.

Next, the above plate was left standing, as shown in FIG. 6 (c), for one hour on the conditions of 23° C. and 50% RH, and the mounting bolts at the four corners were removed. Then, the SUS plate at a laminated sheet side was fixed, and an end part of the SUS plate at an opposite side thereof was peeled off at a speed of 300 mm/minute by means of a tensile test device to measure the peeling force.

### Example 1

### First Embodiment (Refer to FIG. 1)

A polyethylene terephthalate film (trade name: Space Clean S7042, manufactured by Toyobo Co., Ltd.) having a thickness of 50 μm was used as the contractile film. One direction contraction percentage of Space Clean was 55%, and the other direction contraction percentage was 5% (warm water 95° C.×10 seconds).

Further, SP-8LK AO (trade name, manufactured by LINTEC Corporation) was used as the release sheet, and a weak adhesibility type adhesive layer (trade name: MA, acryl base adhesive, manufactured by LINTEC Corporation) having a dry thickness of 30 μm was formed on a release sheet surface by partial coating so that an alternate stripe form in which a width of an adhesive-coated part was 5 mm and in which a width of a non-coated part was 3 mm was obtained, whereby a peelable layer was obtained. Then, the contractile film described above was stuck on the peelable layer surface thereof to prepare a laminated sheet.

Results obtained by subjecting the laminated sheet (length: one direction, width: the other direction) obtained above to the peeling force test described above are shown in Table 1.

### Example 2

### Second Embodiment (Refer to FIG. 2)

SP-8LK AO (trade name, manufactured by LINTEC Corporation) was used as the release sheet, and a strong adhesibility type adhesive layer (trade name: PA-T1, acryl base adhesive, manufactured by LINTEC Corporation) having a dry thickness of 30 μm was formed on a release sheet surface by whole area coating. Then, the adhesive layer of the laminated sheet provided with an adhesive layer was laminated on a polyethylene terephthalate film (trade name: Lumirror #50, manufactured by Toray Industries, Inc.) having a thickness of 50 μm used as the base material.

Then, the peelable layer of the laminated sheet prepared in Example 1 was stuck on the polyethylene terephthalate film described above to prepare a laminated sheet.

Results obtained by subjecting the laminated sheet obtained above to the peeling force test described above are shown in Table 1.

### Example 3

### Third Embodiment (Refer to FIG. 3)

A peelable layer comprising a silicone base resin (100 parts by mass of trade name: X-62-1347, linear polyorganosilicone having vinyl groups at both ends, 2 parts by mass of trade name: CAT-PL-56, a platinum catalyst, both manufactured by Shin-Etsu Chemical Co., Ltd.) having a thickness of 25 μm was formed on the polyethylene terephthalate film (trade name: Lumirror #50, manufactured by Toray Industries, Inc.) having a thickness of 50 μm used as the base material B. Further, an adhesive layer (trade name: PA-T1, acryl base adhesive, manufactured by LINTEC Corporation) having a dry thickness of 30 μm was formed on the polyethylene terephthalate film (trade name: Lumirror #50, manufactured by Toray Industries, Inc.) having a thickness of 50 μm used as the base material A. The release sheet (trade name: SP-8LK AO, manufactured by LINTEC Corporation) was stuck on the adhesive layer.

Then, the peelable layer surface of the base material B was stuck on the polyethylene terephthalate film of the base material A described above to prepare a laminated matter.

Next, SP-8LK AO (trade name, manufactured by LINTEC Corporation) was used as the release sheet, and an adhesive layer (trade name: PK, acryl base adhesive, manufactured by LINTEC Corporation) having a dry thickness of 30 μm was formed on a release sheet surface thereof by whole area coating. Then, the polyethylene terephthalate film (trade name: Space Clean S7042, manufactured by Toyobo Co., Ltd.) having a thickness of 50 μm was stuck thereon as the contractile film.

Then, the release sheet attached to one side of Space Clean S7042 described above was removed, and an exposed adhesive layer surface thereof was stuck on the base material B of the laminated matter described above to prepare a laminated sheet.

Results obtained by subjecting the laminated sheet obtained above to the peeling force test are shown in Table 1.

### Example 4

### Second Embodiment (Refer to FIG. 2), Magnetic Adhesive Layer

### (1) Preparation of Magnetic Adhesive Composition:

A mixer (trade name: T. K. HIVIS MIX 2P-1, manufactured by PRIMIX Corporation) was charged with 200 parts by mass of a strontium ferrite powder (average particle diameter: 2 μm) as a magnetic powder and 100 parts by mass of a polyester resin base hot melt adhesive (trade name: Polyester SP-165, melting temperature: 130° C., manufactured by Nippon Synthetic Chemical Industry Co., Ltd.), and they were mixed for 40 minutes under heating at 160° C. to obtain a magnetic adhesive composition.

### (2) Preparation of Adhesive Sheet:

An extruding machine was charged with the magnetic adhesive composition prepared in (1) to extrude a magnetic adhesive layer having a thickness of 250 μm from a die thereof at an extruding temperature of 160° C., and the above magnetic adhesive layer was laminated on a surface of a release sheet of a polyethylene terephthalate resin sheet (trade name: SP-PET 100 (T), thickness: 100 μm, manufactured by LINTEC Corporation) subjected on a surface thereof to silicon release treatment. Immediately thereafter, a base material sheet (trade name: Lumirror #100T60, polyethylene terephthalate resin sheet, thickness: 100 μm, manufactured by Toray Industries, Inc.) was stuck on a surface of the magnetic adhesive layer, and it was cooled down to room temperature. Next, it was magnetized on the conditions of a voltage of 500 V and a current of 8 kA by means of a high pressure condenser magnetization•demagnetization electric source equipment (trade name: PC2520ND, manufactured by Magnet Labo Co., Ltd.) to prepare an adhesive sheet provided with a base material. The shearing force after heated and adhered was 120 N, and the surface magnetic force was 30 mT at room temperature and 0 mT after heated.

### (3) Preparation of Laminated Sheet:

The polyethylene terephthalate film described above (trade name: Space Clean S7042, manufactured by Toyobo Co., Ltd.) having a thickness of 50 μm was used as the contractile film.

Further, SP-8LK AO (trade name, manufactured by LINTEC Corporation) was used as the release sheet, and the weak adhesibility type adhesive layer (trade name: MA, acryl base adhesive, manufactured by LINTEC Corporation) having a dry thickness of 30 μm was formed on a release sheet surface thereof by partial coating so that an alternate stripe form in which a width of an adhesive-coated part was 5 mm and in which a width of a non-coated part was 3 mm was obtained, whereby a peelable layer was obtained. Then, the contractile film described above was stuck on the peelable layer surface thereof to prepare a laminated matter.

Next, the peelable layer of the laminated matter described above was stuck on a base material sheet of the adhesive sheet to prepare a laminated sheet.

Results obtained by subjecting the laminated sheet obtained above to the peeling force test are shown in Table 1.

### Example 5

### Third Embodiment (Refer to FIG. 3), Magnetic Adhesive Layer

### (1) Preparation of Magnetic Adhesive Composition:

The mixer (trade name: T. K. HIVIS MIX 2P-1, manufactured by PRIMIX Corporation) was charged with 200 parts by mass of a strontium ferrite powder (average particle diameter: 2 μm) as a magnetic powder and 100 parts by mass of a polyolefin resin base hot melt adhesive (trade name: Moresco Melt EP-167, melting temperature: 100° C., manufactured by Matsumura Oil Research Corp.), and they were mixed for 40 minutes under heating at 160° C. to obtain a magnetic adhesive composition.

### (2) Preparation of Adhesive Sheet;

An extruding machine was charged with the magnetic adhesive composition prepared in (1) to extrude a magnetic adhesive layer having a thickness of 250 μm from a die thereof at an extruding temperature of 160° C., and the above magnetic adhesive layer was laminated on a surface of a release sheet of the polyethylene terephthalate resin sheet (trade name: SP-PET-100 (T), thickness: 100 μm, manufactured by LINTEC Corporation) subjected on a surface thereof to silicon release treatment. Immediately thereafter, a base material A (trade name: Lumirror #100T60, polyethylene terephthalate resin sheet, thickness: 100 μm, manufactured by Toray Industries, Inc.) was stuck on a surface of the magnetic adhesive layer, and it was cooled down to room temperature. Next, it was magnetized on the conditions of a voltage of 500 V and a current of 8 kA by means of the high pressure condenser magnetization•demagnetization electric source equipment (trade name: PC2520ND, manufactured by Magnet Labo Co., Ltd.) to prepare an adhesive sheet provided with the base material A. The shearing force after heated and adhered was 100 N, and the surface magnetic force was 30 mT at room temperature and 0 mT after heated.

### (3) Preparation of Laminated Sheet:

A peelable layer comprising the silicone base resin (100 parts by mass of trade name: X-62-1347, linear polyorganosilicone having vinyl groups at both ends, 2 parts by mass of trade name: CAT-PL-56, a platinum catalyst, both manufactured by Shin-Etsu Chemical Co., Ltd.) having a thickness of 25 μm was formed on the polyethylene terephthalate film (trade name: Lumirror #50, manufactured by Toray Industries, Inc.) having a thickness of 50 μm used as the base material B.

Then, the adhesive sheet obtained in (2) in which the magnetic adhesive layer was laminated on one surface of the base material A was used to stick the peelable layer surface of the base material B on the polyethylene terephthalate film of the base material A described above, whereby a laminated matter was prepared.

Next, SP-8LK AO (trade name, manufactured by LINTEC Corporation) was used as the release sheet, and the adhesive layer (trade name: PK, acryl base adhesive, manufactured by LINTEC Corporation) having a dry thickness of 30 μm was formed on the release sheet surface by whole area coating. Then, the polyethylene terephthalate film (trade name: Space Clean S7042, manufactured by Toyobo Co., Ltd.) having a thickness of 50 μm was stuck thereon as the contractile film.

Then, the release sheet attached to one side of Space Clean S7042 described above was removed, and an exposed adhesive layer surface thereof was stuck on the base material B of the laminated matter described above to prepare a laminated sheet.

Results obtained by subjecting the laminated sheet obtained above to the peeling force test described above are shown in Table 1.

### Comparative Example 1

SUS was bonded in the same manner as in Example 1, except that in Example 1, the polyethylene terephthalate film “Lumirror #50” (one direction contraction percentage: 0.3%, the other direction contraction percentage: 0.1% (warm water 95° C.×10 seconds)) (trade name, manufactured by Toray Industries, Inc.) having a thickness of 50 μm was used in place of the contractile film.

Results obtained by subjecting the laminated sheet obtained above to the peeling force test are shown in Table 1.

TABLE 1

| | Peeling force (N/25 mm) |
|---|---|
| Example 1 | 3.8 |
| Example 2 | 3.5 |
| Example 3 | 0.3 |
| Example 4 | 4.7 |
| Example 5 | 0.5 |
| Comparative Example 1 | 8.5 |

### Example 6

The laminated sheet produced in Example 3 was stuck on a stiffener 33 of a roof structure shown in FIG. 7, and a mastic sealer 32 was coated between a roof 31 and the laminated sheet to bond them. After subjected to electrodeposition coating, the roof structure was dried at 150° C. for one hour to find that the peelable layer was peeled off, though bonded before dried, from the base material A and that deformation was not observed in the roof 31.

### INDUSTRIAL APPLICABILITY

As explained above in details, use of the laminated sheet and the bonded matter according to the present invention makes it possible to release bonding when heated. They are suited to, for example, a roof structure, and use thereof for a bonded part between a stiffener for cars and a roof for cars makes it possible to prevent the members from being deformed.

Further, the above laminated sheet and bonded matter can be used as well for members of ships, electric trains and the like in the fields of traffic, transportation and the like.

1. A bonded matter, prepared by a process comprising bonding a first member to a second member with a laminated sheet,
wherein a contractile film comprised by the laminated sheet contracts when the bonded matter is heated, and at least a part of the laminated sheet is peeled off from either of the members, whereby the bonded matter is prevented from being deformed.

2. The bonded matter of claim 1, wherein either of the members is a member for a car.

3. The bonded matter of claim 1, wherein the first member and the second member are a stiffener for a car and a roof for a car respectively.

4. A roof structure, prepared by bonding a stiffener for a car and a roof for a car via a mastic sealer and a laminated sheet,
wherein when the roof structure is heated, a part of the laminated sheet is peeled off or the laminated sheet is peeled off from the stiffener, whereby the roof structure is prevented from being deformed.

5. The bonded matter of claim 1, wherein the laminated sheet comprises:
(i) a contractile film; and
(ii) a peelable layer,
laminated in this order,
wherein the peelable layer is bonded to one member, and
wherein, when the bonded matter is heated, the peelable layer is peeled off from the one member.

6. The bonded matter of claim 1, wherein the laminated sheet comprises:
(i) a contractile film;
(ii) a peelable layer;
(iii) a base material; and
(iv) an adhesive layer,
laminated in this order, and
when the bonded matter is heated, the peelable layer is peeled off from the base material.

7. The bonded matter of claim 6, wherein the adhesive layer is a magnetic adhesive layer comprising a magnetic adhesive composition comprising a mixture of a hot melt adhesive and a ferromagnetic substance.

8. A laminated sheet, comprises:
(i) a contractile film;
(iv) a peelable layer,
laminated in this order
wherein the peelable layer is suitable for bonding to a member to form a bonded matter, and when the bonded matter is heated, the peelable layer is peeled off from the member.

9.-10. (canceled)

11. A method of bonding a first member and a second member with a laminated sheet comprising a peelable layer and a contractile film, the method comprising:
sticking a layer surface from a layer other than the peelable layer of the laminated sheet to one surface side of the first member;
adhering a contractile film surface of the laminated sheet to the second member with an adhesive; and
bonding the first member to the second member.

12. A method of claim 11, wherein the laminated sheet further comprises:
an adhesive layer, and
wherein the layer surface for the sticking is the adhesive layer surface of the laminated sheet.

13. The method of claim 12, wherein the adhesive layer is a magnetic adhesive layer comprising a magnetic adhesive composition comprising a mixture of a hot melt adhesive and a ferromagnetic substance.

14. A method of bonding a first and a second member with the laminated sheet of claim 8, the method comprising:
sticking a first adhesive layer surface of the laminated sheet on one surface side of the first member;
adhering a contractile film surface of the laminated sheet to the second member with an adhesive; and
bonding the first member to the second member.

15. The method of claim 14, wherein the first adhesive layer is a magnetic adhesive layer comprising a magnetic adhesive composition comprising a mixture of a hot melt adhesive and a ferromagnetic substance.

16. The method of claim 11, wherein the surface layer for the sticking is the peelable layer.

17. The laminated sheet of claim 8, further comprising, after the contractile film (i) and the peelable layer (iv):
(v) a base material;
(vi) an adhesive layer,
laminated in this order,
wherein, when a bonded matter comprising the laminated sheet is heated, the peelable layer is peeled off from the base material.

18. The laminated sheet of claim 18, further comprising, between the contractile film (i) and the peelable layer (iv):
(ii) a second adhesive layer;
(iii) a base material B,
and after the peelable layer (iv):
(v) a base material A; and
(vi) a first adhesive layer,
laminated in this order,
wherein, when a bonded matter comprising the laminated sheet is heated, the peelable layer is peeled off from the base material A.

19. The laminated sheet of claim 8, wherein the first adhesive layer is a magnetic adhesive layer comprising a magnetic adhesive composition comprising a mixture of a hot melt adhesive and a ferromagnetic substance.

20. The laminated sheet of claim 8, wherein a contraction percentage (95° C.) of the contractile film in one direction is 30% or more.
